(19) United States
(12) Patent Application Publication
(10) Pub. No.: US 2009/0086226 A1
(43) Pub. Date: Apr. 2, 2009

(54) IMAGE FORMING SYSTEM, IMAGE PROCESSING APPARATUS AND IMAGE PROCESSING METHOD

(75) Inventors: Satoru IGUCHI, Tokyo (JP); Katsuyoshi Yamanouchi, Fukushima (JP); Kazuyuki Yamada, Fukishima (JP)

Correspondence Address: RABIN & Berdo, PC, 1101 14TH STREET, NW, SUITE 500, WASHINGTON, DC, 20005, US

(73) Assignee: OKI DATA CORPORATION, Tokyo (JP)

(21) Appl. No.: 12/239,088

(22) Filed: Sep. 26, 2008

(30) Foreign Application Priority Data
Sep. 28, 2007 (JP) JP2007-253509
Aug. 19, 2008 (JP) JP2008-210955

(51) Int. Cl. H04N 1/60

(52) U.S. Cl. 358/1.9

(57) ABSTRACT

An image forming system supplied capable of keeping a high thruput when performing a background pattern data print (e.g. Anoto print). The image forming system comprises a color image processing apparatus and a color image forming apparatus that is connected with the color image processing apparatus, wherein the color image processing apparatus has a color changing section that uses one of CMYK values to designate background pattern data when performing a CMYK change with respect to color image data generated in the color image processing apparatus; wherein the color image forming apparatus has an image forming section that receives the color image data that has been performed by the CMYK change and the background pattern data that has been designated by one of CMYK values from the color image processing apparatus, and compounds the both data to form an color image.

### CROSS REFERENCE TO RELATED APPLICATIONS

This application claims priority based on 35 USC 119 from prior Japanese Patent Application No. JP2008-210955 filed on Aug. 19, 2008, the entire contents of which are incorporated herein by reference.

### FIELD OF THE INVENTION

The invention relates to an image forming system in which a color image processing apparatus and a color image forming apparatus are connected; relates to a color image processing apparatus connected with a color image forming apparatus; and relates to an image processing method.

### BACKGROUND OF THE INVENTION

FIG. 7 is a block diagram showing a structure of a conventional image forming system to perform an Anoto print (I).

Conventionally, as shown by FIG. 7, an Anoto print is performed by using an image forming system in which a host computer 70 such as personal computer (PC) and a printer 80 are connected via cable (not shown). That is, in the conventional image forming system, the host computer 70 sends image data composed of (R, G, B) values and sends Anoto pattern data to the printer 80 via the cable; the printer 80 performs a complement change (C=1-R, M=1-G, Y=1-B) with respect to the image data composed of the (R, G, B) values (R (Red), G (Green), B (Blue)) so as to generate image data that is composed of (C, M, Y, K (K=0)) values. Then, the printer 80 performs a layer thickness control, compounds the generated image data composed of the (C, M, Y, K (K=0)) values with the Anoto pattern data sent from the host computer 70 as an image; and prints the compounded image data of the image onto a print medium. Regarding the expression of K=0 in (C, M, Y, K (K=0)) described above, it indicates that there is no color “K”.

On the one hand, a coloring of image displayed on a displayer of the host computer 70, is obtained through basing the (R, G, B) values of image data upon a standard RGB profile (S-RGB profile). On the other hand, a coloring of image printed on the print medium by the printer 80 is obtained according to the (C, M, Y, K (K=0)) values obtained by performing a complement change with respect to the (R, G, B) values of image data sent from the host computer 70. Thereby, even if using the identical image data, the coloring of the image displayed on displayer in host computer is different from the coloring of the image printed on the print medium printed by printer.

Though the coloring of the image displayed on displayer in host computer is different from the coloring of the image printed on the print medium printed by printer, as a wish of user, it is desirable to make both the coloring of the image displayed on displayer in host computer and the coloring of the image printed on the print medium printed by printer become to coincide.

FIG. 8 is a block diagram showing a structure of a conventional image forming system to perform an Anoto print (II).

In order to realize the wish of user, in the conventional image forming system, as shown by FIG. 8, the host computer 70 sends image data composed of (R, G, B) values and sends Anoto pattern data to the printer 80 via the cable; the printer 80 performs a complement change (C=1-R, M=1-G, Y=1-B) with respect to the image data so as to generate image data that is composed of (C, M, Y, K (K=0)) values. Next, the printer 80 changes the image data composed of (C, M, Y, K (K=0)) values into image data composed of (C, M, Y, K (K=0)) values that can make the coloring of the image printed on the print medium become approximate to the coloring of the image displayed on displayer, on the basis of a link profile 803. Then, a layer thickness control section 801 controls the (C, M, Y, K (K=0)) values of the changed image data on the basis of the link profile 803 and controls layer thicknesses of toner layers of all colors on the basis of K values of the Anoto pattern data; and a print processing section 802 performs an image compound to compound the image data composed of the (C, M, Y, K (K=0)) values changed on the basis of the link profile 803 with the Anoto pattern data only composed of K values, and prints the compounded image onto print medium (for example, refer to the following patent document 1). Thus, the image printed on the print medium has an approximate coloring to the coloring of the image displayed on displayer, and an image of the Anoto pattern data is printed on the print medium.

The patent document 1 is Japan patent publication 2005-169798.

However, in the image forming system enabling the coloring of the image printed on the print medium to be approximate to the coloring of the image displayed on displayer, on the side of the printer, because it is necessary to perform complement change process, profile change process using a profile for coloring approximation (i.e. coloring approximation use profile) and layer thickness control process, to there are problems that an excessive load exists with respect to print process, and thruput concerning the print process lowers.

### SUMMARY OF THE INVENTION

The invention is to provide an image forming system, an image processing apparatus and an image processing method capable of solving the above problem. That is, the invention can keep a high thruput when performing an Anoto print of the image having an approximate coloring to the coloring of the image displayed on displayer, onto print medium.

A first aspect of the invention is to provide an image forming system. The image forming system comprises a color image processing apparatus; and a color image forming apparatus that is connected with the color image processing apparatus, wherein the color image processing apparatus has a color changing section that uses one of CMYK values to designate background pattern data when performing a CMYK change with respect to color image data generated in the color image processing apparatus; and wherein the color image forming apparatus has an image forming section that receives the color image data that has been performed by the CMYK change and the background pattern data that has been designated by one of CMYK values from the color image processing apparatus, and compounds the both data to form an color image.

A second aspect of the invention is to provide an image processing apparatus that is connected with a color image forming apparatus that compounds color image data with background pattern data. The color image processing apparatus comprises a color changing section that uses one of CMYK values to designate background pattern data when performing a CMYK change with respect to color image data that is previously generated; and a sending section that sends the color image data that has been performed by the CMYK change and the background pattern data that has been designated by one of CMYK values to the color image forming apparatus.

A third aspect of the invention is to provide an image processing method that outputs a print instruction to a color image forming apparatus that compounds color image data with background pattern data. The image processing method comprises steps of using one of CMYK values to designate background pattern data when performing a CMYK change with respect to color image data that is previously generated; and sending the color image data that has been performed by the CMYK change and the background pattern data that has been designated by one of CMYK values to the color image forming apparatus.

### EFFECT OF THE INVENTION

According to the invention, it is possible to keep a high thruput when performing a background pattern data print (e.g. Anoto print) of the image having an approximate coloring to the coloring of the image displayed on displayer, onto print medium.

The above features of the present invention will become apparent from the following detailed description and the appended claims with reference to the accompanying drawings.

### BRIEF DESCRIPTION OF THE DRAWINGS

FIG. 1 is a block diagram showing a structure of an image forming system in embodiment 1 of the present invention;

FIG. 2 is a flow chart showing operation of an image forming system in embodiment 1 of the present invention;

FIG. 3 is a block diagram showing a structure of an image forming system in embodiment 2 of the present invention;

FIG. 4 is a flow chart showing operation of an image forming system in embodiment 2 of the present invention;

FIG. 5 is a block diagram showing a structure of an image forming system in embodiment 3 of the present invention;

FIG. 6 is a flow chart showing operation of an image forming system in embodiment 3 of the present invention;

FIG. 7 is a block diagram showing a structure of a conventional image forming system to perform an Anoto print (I);

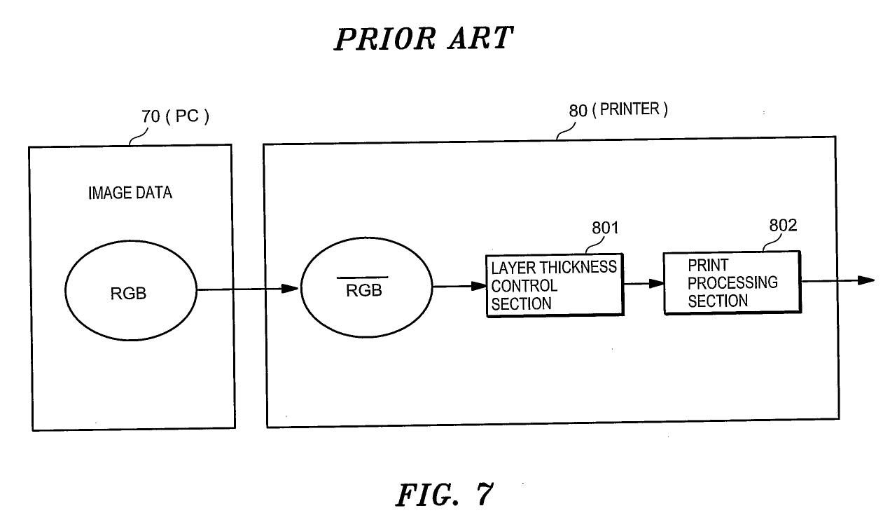

FIG. 8 is a block diagram showing a structure of a conventional image forming system to perform an Anoto print (II);

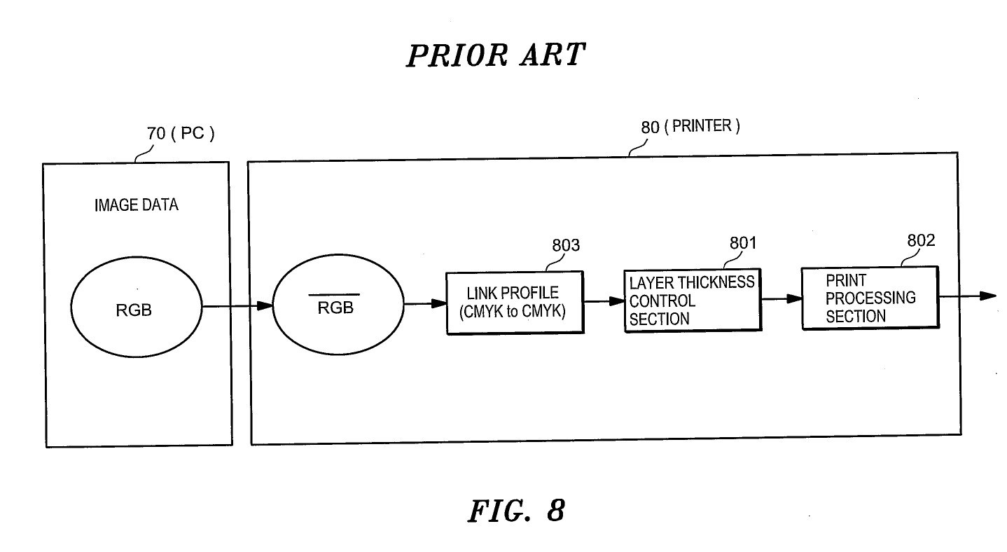

FIG. 9 is a block diagram showing a structure of an image forming system in embodiment 4 of the present invention;

FIG. 10 is a diagram showing flow of signal in an image forming system of embodiment 4 of the present invention;

FIG. 11 is a diagrams showing basic Anoto dots;

FIG. 12 is a diagram showing combinations of basic Anoto dots;

FIG. 13A˜FIG. 13B are diagrams showing Anoto pattern according to basic Anoto dots; and

FIG. 14A˜FIG. 14B are diagrams showing Anoto pattern according to combinations of basic Anoto dots;

### DETAILED DESCRIPTION OF THE PREFERRED EMBODIMENTS

Embodiments of the invention will be described in detail hereinbelow with reference to the drawings.

### Embodiment 1

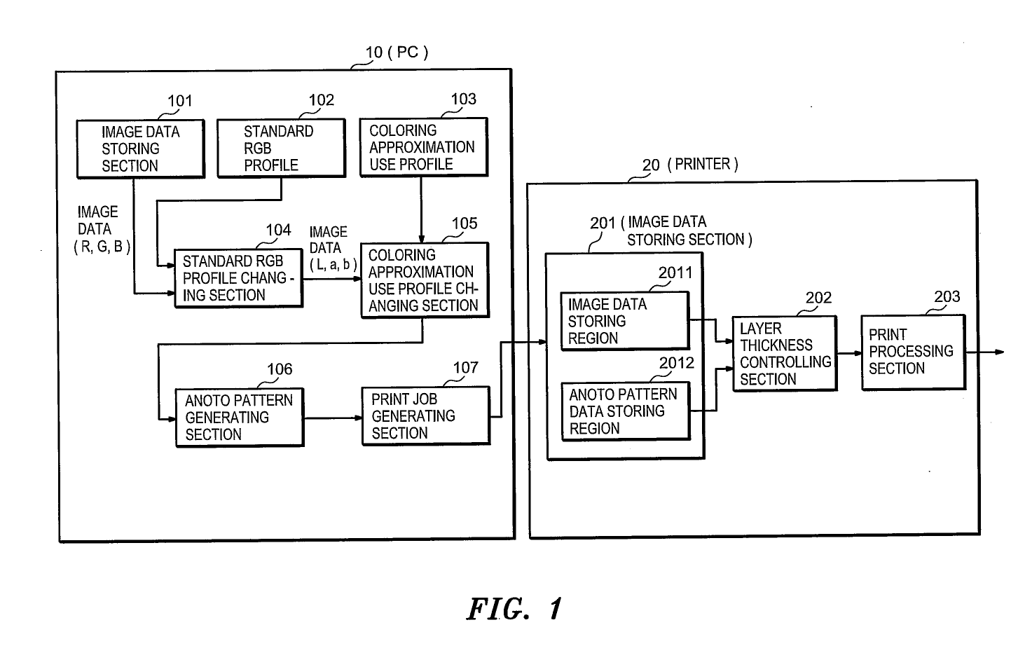

FIG. 1 is a block diagram showing a structure of an image forming system in embodiment 1 of the present invention.

As shown by FIG. 1, in an image forming system of the embodiment 1, a personal computer (hereinafter: PC) 10 which serves as an color image processing apparatus and a printer 20 which serves as an color image forming apparatus are connected via cable (not shown).

The PC 10 includes an image data storing section 101, a standard RGB profile 102, a coloring approximation use profile 103, a standard RGB profile changing section 104, a coloring approximation use profile changing section 105, an Anoto pattern generating section 106 and a print job generating section 107.

The standard RGB profile changing section 104 is formed through a CPU (not shown) executes a standard RGB profile change control program stored in a ROM (not shown). The coloring approximation use profile changing section 105 is formed through the same CPU (not shown) executes a coloring approximation use profile change control program stored in the same ROM (not shown). The Anoto pattern generating section 106 is formed through the same CPU (not shown) executes an Anoto pattern generation control program stored in the same ROM (not shown). Moreover, in the standard RGB profile change control program and the coloring approximation use profile change control program, for example, there is an Acrobat Distiller to form Acrobat (it is an application name supplied by Adobe company) that is a control program for generating a PDF file. In the Anoto pattern generation control program, there is an AcrobatFDT plugged in by the Acrobat.

The image data storing section 101 stores image data read out by a scanner, image data of image to be printed by the printer 20, and the like. The image data is composed of (R, G, B) values.

The standard RGB profile 102 is used for changing the image data composed of the (R, G, B) values and stored in the image data storing section 101 into image data composed of (L, a, b) values. A data formation of the standard RGB profile 102 is in a table form. Moreover, the standard RGB profile 102 is packaged by the Acrobat Distiller.

The coloring approximation use profile 103 is a profile used to make a coloring of an image to be printed on print medium become approximate to a coloring of an image displayed on displayer; also is a file used to change the image data composed of the (L, a, b) values displayed on displayer into image data composed of (C, M, Y, K (K=0)) values to be printed on print medium. A data formation if the coloring approximation use profile 103 is in table form.

Moreover, because the printer 20 prints an image which is obtained by compounding image data with Anoto pattern data of K color (black color) when the printer 20 performs an Anoto print, the coloring approximation use profile 103 always changes the image data composed of (L, a, b) values into the image data composed of (C, M, Y, K (K=0)) values without K values (i.e. without black color). Further, the coloring approximation use profile 103 incorporates a profile generated by a profile change device or a profile generated by tool to make profile according to a request of user in the Acrobat Distiller.

The standard RGB profile changing section 104 changes the image data composed of (R, G, B) values stored in the image data storing section 101 into the image data composed of (L, a, b) values on the basis of the standard RGB profile 102, and outputs the changed image data to the coloring approximation use profile changing section 105. The image data that is changed to the image data composed of (L, a, b) values by the standard RGB profile changing section 104 is image data of an image that is displayed on displayer.

The coloring approximation use profile changing section 105 changes the image data composed of (L, a, b) values inputted from the standard RGB profile changing section 104 into image data composed of (C, M, Y, K (K=0)) values on the basis of the coloring approximation use profile 103, and stores the image data into a RAM (not shown). The image data that is changed to the (C, M, Y, K (K=0)) values from the (L, a, b) values by the coloring approximation use profile changing section 105 is image data of an image to be printed on print medium.

The Anoto pattern generating section 106 generates Anoto pattern data of an Anoto pattern image to be compounded with the image to be printed on print medium by the printer 20, and stores the Anoto pattern data into RAM, the Anoto pattern data serves as background pattern data. Anoto pattern is formed by dots, respective dots are respectively formed by dot patterns that are more fine and are different each other. Through a pattern reading mechanism built-in Anoto pen reads the dot pattern of each dot, an absolute position of the dot pattern on print medium is detected.

The print job generating section 107, when a generation request of print job is inputted from the Anoto pattern generating section 106, reads out the image data composed of (C, M, Y, K (K=0)) values and the Anoto pattern data from the RAM, and generates a print job described by these image data. Then, the print job generating section 107 sends the generated print job via cable.

The printer 20 includes an image data storing section 201, a layer thickness controlling section 202, and a print processing section 203.

The image data storing section 201 has an image data storing region 2011 to store the image data composed of (C, M, Y, K (K=0)) values sent from the PC 10 via cable, and an Anoto pattern data storing region 2012 to store the Anoto pattern data sent from the PC 10 via cable.

The layer thickness controlling section 202 calculates and corrects a toner amount of C, a toner amount of M, a toner amount of Y and a toner amount of K, on the basis of the (C, M, Y, K (K=0)) values of the image data stored in the image data storing region 2011 and K values of the Anoto pattern data stored in the Anoto pattern data storing region 2012, so that a total toner amount on respective dots becomes a predetermined amount or below; and outputs the corrected toner amounts of respective colors to the print processing section 203.

The print processing section 203 compounds an image of the image data with an Anoto pattern image of the Anoto pattern data; and prints a compound image on print medium.

Next, it is to explain operation of the image forming system of the embodiment 1 of the present invention.

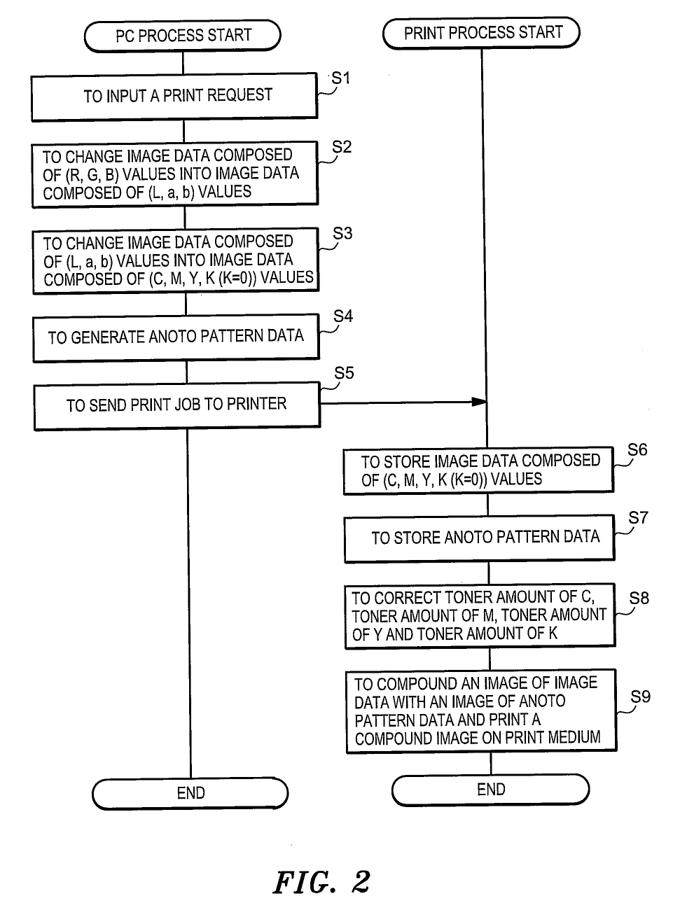

FIG. 2 is a flow chart showing operation of an image forming system in embodiment 1 of the present invention.

Firstly, after print request information, that is, a file name of image data that is requested to print is inputted to the PC 10 by user (step 1), the standard RGB profile changing section 104 sequentially reads out the image data of the file name designated by user from the image data storing section 101; and changes the image data composed of (R, G, B) values into image data composed of (L, a, b) values on the basis of the standard RGB profile 102 (step 2); and outputs the image data composed of (L, a, b) values to the coloring approximation use profile changing section 105.

The coloring approximation use profile changing section 105 changes the image data composed of (L, a, b) values inputted from the standard RGB profile changing section 104 into image data composed of (C, M, Y, K (K=0)) values on the basis of the coloring approximation use profile 103 (step 3), and writes the image data into the RAM. Then, the coloring approximation use profile changing section 105 outputs a generation request of Anoto pattern data to the Anoto pattern generating section 106.

The Anoto pattern generating section 106, when the generation request is inputted from the coloring approximation use profile changing section 105, generates Anoto pattern data on the basis of an Anoto pattern generation control program (step 4), and writes the Anoto pattern data into RAM. Then, the Anoto pattern generating section 106 outputs a generation request of print job to the print job generating section 107.

The print job generating section 107, when the generation request of print job is inputted from the Anoto pattern generating section 106, reads out the image data composed of (C, M, Y, K (K=0)) values and the Anoto pattern data from the RAM, and generates a print job described by these image data. Then, the print job generating section 107 sends the generated print job via cable (step 5).

The printer 20, when received the print job from the PC 10, writes the image data composed of (C, M, Y, K (K=0)) values described in the print job to the image data storing region 2011 of the image data storing section 201 (step 6).

The printer 20, after wrote the image data into the image data storing region 2011, writes the Anoto pattern data described in the print job into the Anoto pattern data storing region 2012 of the image data storing section 201 (step 7).

Then, the layer thickness controlling section 202 calculates and corrects a toner amount of C, a toner amount of M, a toner amount of Y and a toner amount of K, on the basis of the (C, M, Y, K (K=0)) values of the image data stored in the image data storing region 2011 and K values of the Anoto pattern data stored in the Anoto pattern data storing region 2012 so as to make a total toner amount on respective dots become a predetermined amount or below (step 8); and outputs the corrected toner amounts of respective colors to the print processing section 203.

The print processing section 203 compounds an image of the image data with an Anoto pattern image of the Anoto pattern data on the basis of the toner amounts of respective colors that are inputted from the print processing section 203; prints a compound image on print medium (step 9); and ends process.

According to the embodiment 1, because the coloring approximation use profile changing section 105 of the PC 10 changes the image data composed of (L, a, b) values inputted from the standard RGB profile changing section 104 into the image data composed of (C, M, Y, K (K=0)) values on the basis of the coloring approximation use profile 103, when the printer 20 performs an Anoto print of the image data received from the PC 10 onto print medium, it is unnecessary to perform a complement change process and link profile change process that were performed in prior art. Therefore, it is possible to keep a high thruput when the printer 20 performs an Anoto print.

### Embodiment 2

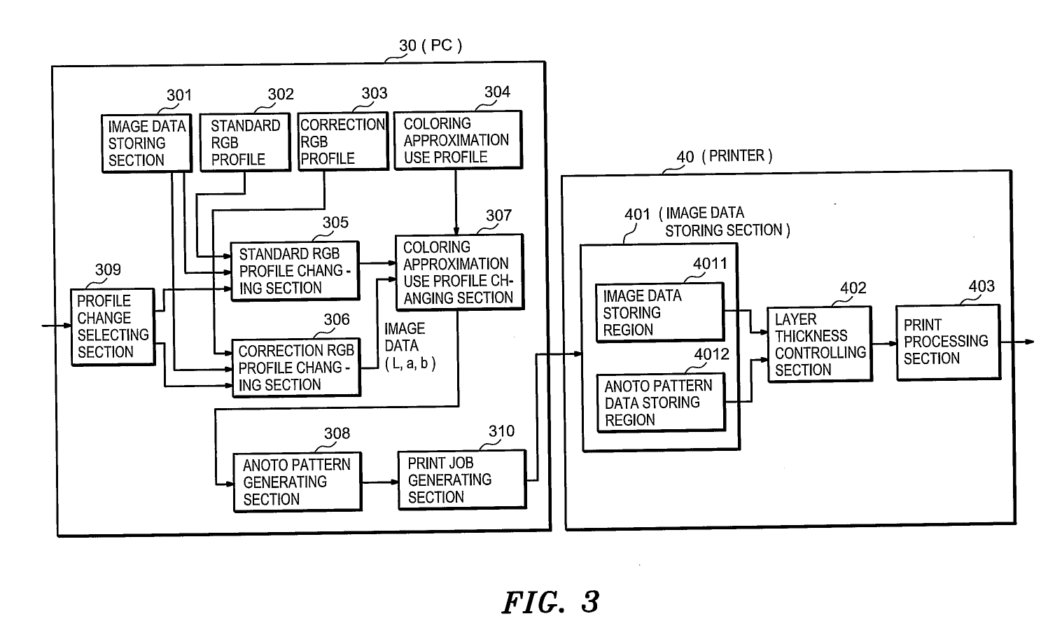

FIG. 3 is a block diagram showing a structure of an image forming system in embodiment 2 of the present invention.

As shown by FIG. 3, like the embodiment 1 of the image forming system, in an image forming system of the embodiment 2, a personal computer (hereinafter: PC) 30 which serves as an color image processing apparatus and a printer 40 which serves as an color image forming apparatus are connected via cable (not shown).

The PC 30, like the embodiment 1, is an apparatus to execute either of a process (hereinafter: approximation process) that generates image data whose image to be printed on print medium by printer 40 has a coloring that is approximate to the coloring of image displayed on displayer; and a process (hereinafter: conventional process) that generates an image which is printed on print medium by printer 40 has a conventional familiar coloring that is different from the coloring of image displayed on displayer. Here, as a reason to execute the conventional process, it is for replying to a request that user wishes to actively use such image data which serves as information resource and whose image printed on print medium has a coloring that has been corrected to an objective coloring; or a request that user wishes to print such image which has a conventional familiar coloring that is different from the coloring of image displayed on displayer, onto print medium.

The PC 30 includes an image data storing section 301, a standard RGB profile 302, a correction RGB profile 303, a coloring approximation use profile 304, a standard RGB profile changing section 305, a correction RGB profile changing section 306, a coloring approximation use profile changing section 307, an Anoto pattern generating section 308, a profile change selecting section 309 and a print job generating section 310.

The image data storing section 301, like the embodiment 1, stores image data read out by a scanner, image data of image to be printed by the printer 40, and the like. Further, the image data storing section 301 stores image data corrected by user so as to make the coloring of the image printed on print medium become an object coloring.

The correction RGB profile 303 is a file for changing the image data composed of (R, G, B) values stored in the image data storing section 301 into image data composed of (L, a, b) values that make an image having conventional familiar coloring be performed by an Anoto print on print medium. A data formation of the correction RGB profile 303 is in a table form. Moreover, the correction RGB profile 303 incorporates a profile generated by tool to make profile according to a request of user in the Acrobat Distiller.

The correction RGB profile changing section 306 changes the image data composed of (R, G, B) values stored in the image data storing section 301 into the image data composed of (L, a, b) values on the basis of the correction RGB profile 303, and outputs the changed image data to the coloring approximation use profile changing section 307. The image data that is changed to the image data composed of (L, a, b) values by the correction RGB profile changing section 306 is image data of an image which is printed in print medium with a conventional familiar coloring.

The profile change selecting section 309, when print request information is inputted by user, in which process designation information to designate the approximation process or the conventional process and a file name to store image data of an image to be printed, are described, judges whether the process designation information described in the print request information represents the approximation process or the conventional process. On the one hand, if the process designation information represents the approximation process, the profile change selecting section 309 outputs the inputted file name to the standard RGB profile changing section 305; on the other hand, if the process designation information represents the conventional process, the profile change selecting section 309 outputs the inputted file name to the correction RGB profile changing section 306.

Moreover, in the PC 30, the image data storing section 301 the standard RGB profile 302, the coloring approximation use profile 304, the standard RGB profile changing section 305, the coloring approximation use profile changing section 307 and the Anoto pattern generating section 308 print job generating section 310 are the same as the image data storing section 101, the standard RGB profile 102, the coloring approximation use profile 103, the standard RGB profile changing section 104, the coloring approximation use profile changing section 105, the Anoto pattern generating section 106 and the print job generating section 107 in embodiment 1.

The printer 40 includes an image data storing section 401, a layer thickness controlling section 402, and a print processing section 403. The image data storing section 401, the layer thickness controlling section 402, and the print processing section 403 are the same as the image data storing section 201, the layer thickness controlling section 202, and the print processing section 203 in embodiment 1.

Next, it is to explain operation of the image forming system of the embodiment 2 of the present invention.

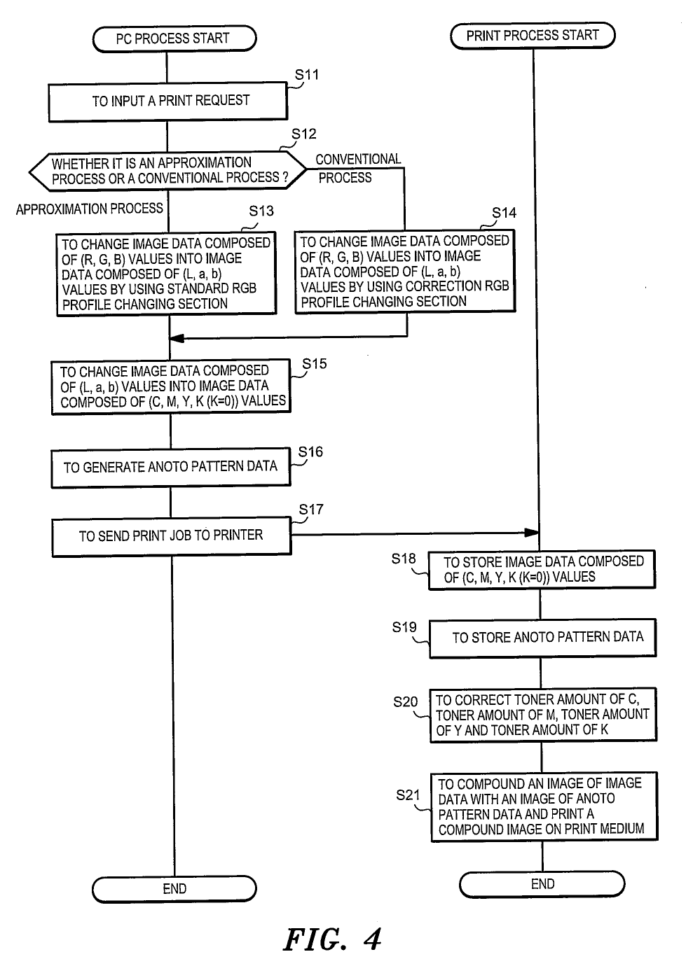

FIG. 4 is a flow chart showing operation of an image forming system in embodiment 2 of the present invention.

When print request information is inputted by user (step 11), the profile change selecting section 309 judges whether the print request information relates to an approximation process or a conventional process (step 12). The profile change selecting section 309, when judged that the print request information relates to an approximation process (step 12, approximation process), outputs a file name requested by user to the standard RGB profile changing section 305.

The standard RGB profile changing section 305, when the file name is inputted from the profile change selecting section 309, sequentially reads out the image data of the file name from the image data storing section 301; and changes the image data composed of (R, G, B) values into image data composed of (L, a, b) values on the basis of the standard RGB profile 302 (step 13). Further, the standard RGB profile changing section 305 outputs the image data composed of (L, a, b) values to the coloring approximation use profile changing section 307. Then, the flow (process) is shifted to step S15.

In step S12, the profile change selecting section 309, when judged that print request information relates to a conventional process (step 12, conventional process), outputs the file name requested by user to the correction RGB profile changing section 306.

The correction RGB profile changing section 306, when the file name is inputted from the profile change selecting section 309, sequentially reads out the image data of the file name from the image data storing section 301; and changes the image data that is composed of (R, G, B) values and has been read out, into the image data composed of (L, a, b) values on the basis of the correction RGB profile 303 (step 14). Further, the correction RGB profile changing section 306 outputs the changed image data composed of (L, a, b) values to the coloring approximation use profile changing section 307. Then, the flow (process) is shifted to step S16.

Through the correction RGB profile changing section 306, the image data which is changed from (R, G, B) values to (L, a, b) values corresponds to an image to be printed on print medium with a conventional familiar coloring; and is different from the image data composed of (L, a, b) values changed by the standard RGB profile changing section 305.

The following processes from step S15 in which the coloring approximation use profile changing section 307 changes the image data composed of (L, a, b) values inputted from the standard RGB profile changing section 305 or the correction RGB profile changing section 306 into image data composed of (C, M, Y, K (K=0)) values to step 21 in which the printer 40 compounds an image of the image data composed of (C, M, Y, K (K=0)) values sent from the PC 30 with an image of Anoto pattern data and prints a compound image onto print medium, are the same as the processes in embodiment 1 from step S3 to step S9.

According to the embodiment 2, it is possible to obtain the same effect as that in embodiment 1. Further, according to the print request information of user, when the conventional process is requested, the correction RGB profile changing section 306 changes the image data composed of (R, G, B) values read out from the image data storing section 301 into image data composed of (L, a, b) values that can make an image be printed on print medium with a conventional familiar coloring, on the basis of the correction RGB profile 303. Therefore, it is possible that the printer 40 performs an Anoto print to print an image onto print medium with a conventional familiar coloring, without a coloring displayed on displayer. As a result, it is possible to reply to a request that user wishes to actively use such image data which serves as information resource and whose image printed on print medium has a coloring that has been corrected to an objective coloring.

### Embodiment 3

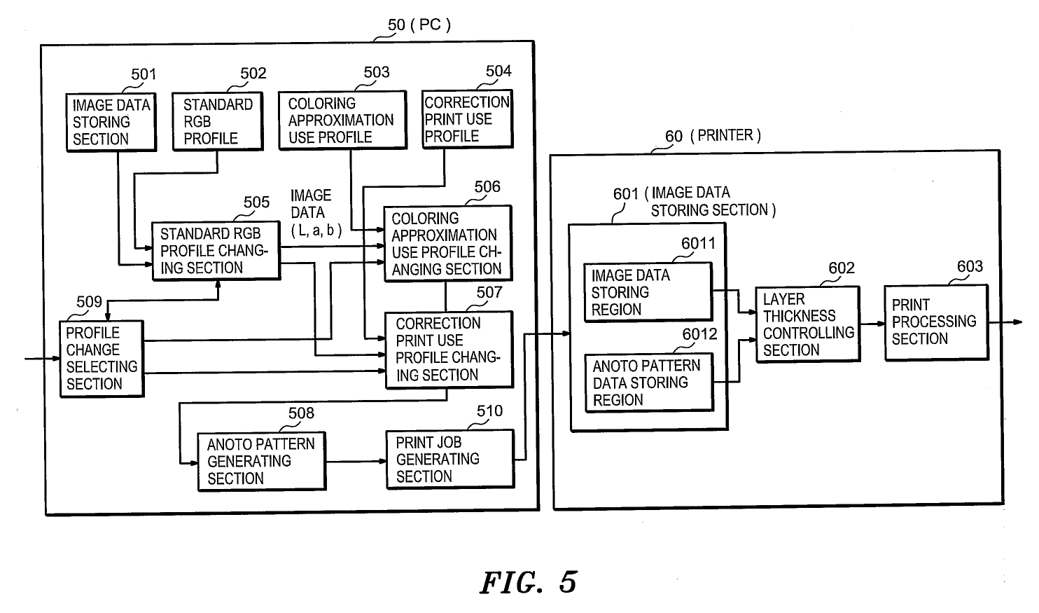

FIG. 5 is a block diagram showing a structure of an image forming system in embodiment 3 of the present invention.

As shown by FIG. 3, like the embodiments 1 and 2 of the image forming system, in an image forming system of the embodiment 2, a personal computer (hereinafter: PC) 50 which serves as an color image processing apparatus and a printer 60 which serves as an color image forming apparatus are connected via cable (not shown).

The PC 50, like the embodiment 2, is an apparatus to send either of image data whose image to be printed on print medium by printer 60 has a coloring that is approximate to the coloring of image displayed on displayer; and image data that makes an image which is printed on print medium by printer 60 have a conventional familiar coloring that is different from the coloring of image displayed on displayer in the case that user has a request, to the printer 60.

The PC 50 includes an image data storing section 501, a standard RGB profile 502, a coloring approximation use profile 503, a correction print use profile 504, a standard RGB profile changing section 505, a coloring approximation use profile changing section 506, a correction print use profile changing section 507, an Anoto pattern generating section 508, a profile change selecting section 509 and a print job generating section 510. Here, the image data storing section 501, the standard RGB profile 502, the coloring approximation use profile 503, the standard RGB profile changing section 505, the coloring approximation use profile changing section 506, the Anoto pattern generating section 508, and a print job generating section 510 are the same as that in embodiments 1 and 2

The correction print use profile 504 is a file for changing image data composed of (L, a, b) values into image data composed of (C, M, Y, K (K=0)) values that make an image having conventional familiar coloring be performed by an Anoto print on print medium. A data formation of the correction print use profile 504 is in a table form. Moreover, the correction print use profile 504 incorporates a profile generated by tool to make profile according to a request of user in the Acrobat Distiller.

The correction print use profile changing section 507 changes the image data that is inputted from the standard RGB profile changing section 505 and is composed of (L, a, b) values indicating a coloring of an image displayed on displayer, into image data composed of (C, M, Y, K (K=0)) values that enable an image having conventional familiar coloring that is different from the coloring displayed on displayer to be performed by an Anoto print on print medium, on the basis of the correction print use profile 504; and outputs the changed image data to the printer 60 via connection cable. Further, the correction print use profile changing section 507, after sent the image data composed of (C, M, Y, K (K=0)) values to the printer 60, outputs a start instruction to the Anoto pattern generating section 508.

The profile change selecting section 509 judges whether the process designation information described in the print request information represents an approximation process or an conventional process. On the one hand, if the process designation information represents the approximation process, the profile change selecting section 509, after outputted a start instruction to the coloring approximation use profile changing section 506, further outputs the file name described in the print request information to the standard RGB profile changing section 505. On the other hand, if the process designation information represents the conventional process, the profile change selecting section 509, after outputted a start instruction to the correction print use profile changing section 507, further outputs the file name to the standard RGB profile changing section 505.

The printer 60 includes an image data storing section 601, a layer thickness controlling section 602, and a print processing section 603. The image data storing section 601, the layer thickness controlling section 602, and the print processing section 603 are the same as that in embodiments 1 and 2.

Next, it is to explain operation of the image forming system of the embodiment 3 of the present invention.

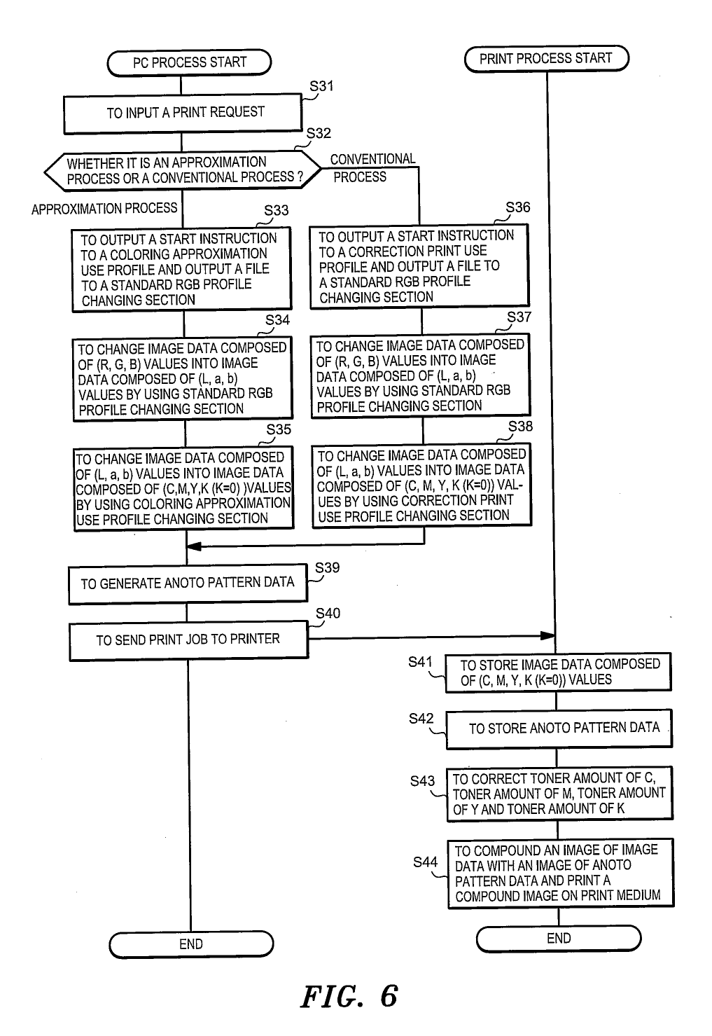

FIG. 6 is a flow chart showing operation of an image forming system in embodiment 3 of the present invention.

When print request information is inputted by user (step 31), the profile change selecting section 509 judges whether the process designation information described in the print request information represents an approximation process or a conventional process (step 32). The profile change selecting section 509, when judged that the process designation information described in the print request information represents an approximation process (step 32, approximation process), outputs a start instruction to the coloring approximation use profile changing section 506 (step 33). Further, the profile change selecting section 509 outputs a file name described in the print request information to the standard RGB profile changing section 505.

The standard RGB profile changing section 505, when the file name is inputted from the profile change selecting section 509, sequentially reads out the image data of the file name from the image data storing section 501; and changes the image data composed of (R, G, B) values into image data composed of (L, a, b) values on the basis of the standard RGB profile 502 (step 34). Further, the standard RGB profile changing section 505 outputs the image data composed of (L, a, b) values to the coloring approximation use profile changing section 506.

The coloring approximation use profile changing section 506 changes the image data composed of (L, a, b) values inputted from the standard RGB profile changing section 505 into image data composed of (C, M, Y, K (K=0)) values on the basis of the coloring approximation use profile 503 (step 35); and writes the image data into RAM. Then, the coloring approximation use profile changing section 506 outputs a notification representing that the image data has been written to the RAM, to the Anoto pattern generating section 508. Then, the flow (process) is shifted to step S39.

In step S32, the profile change selecting section 509, when judged that the process designation information described in the print request information represents a conventional process (step 32, conventional process), outputs a start instruction to the correction print use profile changing section 507 (step 36). Further, the profile change selecting section 509 outputs the file name described in the print request information to the standard RGB profile changing section 505.

The standard RGB profile changing section 505, when the file name is inputted from the profile change selecting section 509, sequentially reads out the image data of the file name from the image data storing section 501; changes the image data that is composed of (R, G, B) values and has been read out, into the image data composed of (L, a, b) values on the basis of the correction RGB profile 303 on the basis of the standard RGB profile 502 (step 37); and outputs the changed image data composed of (L, a, b) values to the correction print use profile changing section 507.

The correction print use profile changing section 507 changes the image data that is inputted from the standard RGB profile changing section 505 and is composed of (L, a, b) values into image data composed of (C, M, Y, K (K=0)) values on the basis of the correction print use profile 504 (step 38); and writes the image data into RAM. Then, the correction print use profile changing section 507 outputs a generation instruction of Anoto pattern data to the Anoto pattern generating section 508.

The following processes from step S39 in which the Anoto pattern generating section 508 generates Anoto pattern data to step 44 in which the printer 60 compounds an image of the image data composed of (C, M, Y, K (K=0)) values sent from the PC 50 with an image of Anoto pattern data and prints a compound image onto print medium, are the same as the processes in embodiment 1 from step S4 to step S9.

According to the embodiment 3, it is possible to obtain the same effect as that in embodiment 1. Further, according to the print request information of user, when the conventional process is requested, the correction print use profile changing section 507 changes the image data composed of (L, a, b) values inputted from the standard RGB profile changing section 505 into the image data composed of (C, M, Y, K (K=0)) values that can make an image be printed on print medium with a conventional familiar coloring. Therefore, it is possible that the printer 60 performs an Anoto print to print an image onto print medium with a conventional familiar coloring that is different from a coloring displayed on displayer. As a result, it is possible to reply to a request that user wishes to actively use such image data which serves as information resource and whose image printed on print medium has a coloring that has been corrected to an objective coloring.

The coloring approximation use profile is selectable and can be updated so as to suit printer to be changed. For example, through storing previously a coloring approximation use profile that is exclusively used by printer into a memory in the printer and performing a communication between the printer and PC when the printer and the PC are connected, the coloring approximation use profile in the printer is sent to the PC. Thus, the coloring approximation use profile may be another profile as new profile; also may be a profile of new version.

Further, in the memory of the printer, a homepage address of a business company of the printer can be stored. Thus, through performing a communication between the printer and PC when the printer and the PC are connected, the PC can refer to the homepage address stored in the printer and access the homepage of the business company to download the coloring approximation use profile used for printer from the homepage. Furthermore, it is possible to perform an update of the coloring approximation use profile by using record medium such as USB or compact disk CD for suiting an update of printer driver.

### Embodiment 4

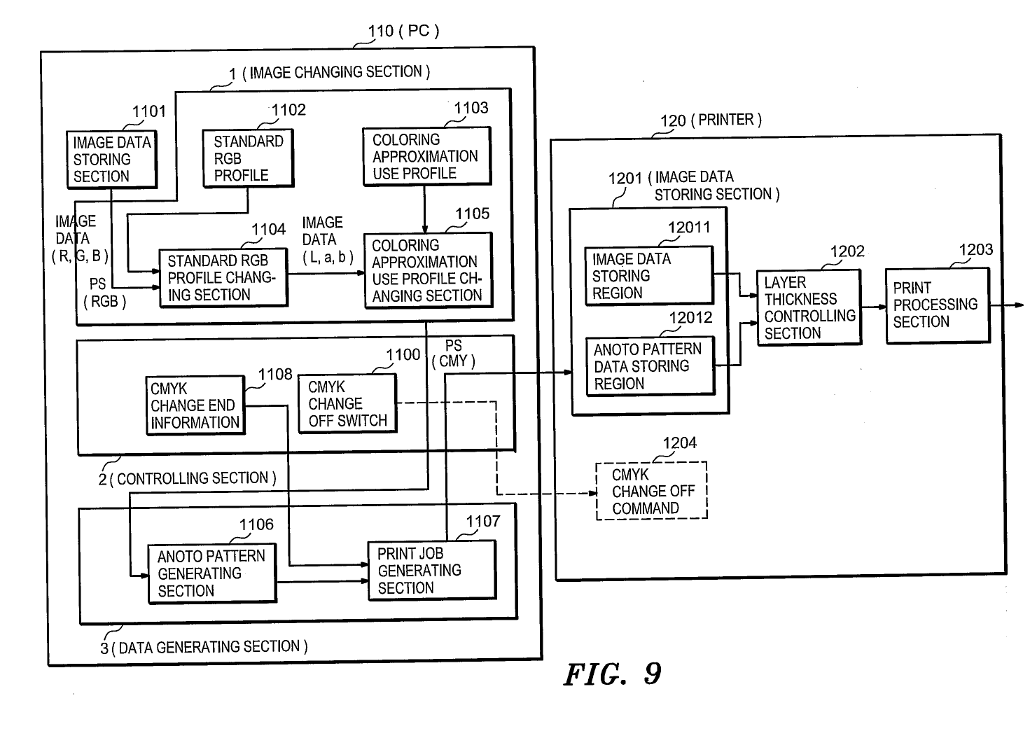

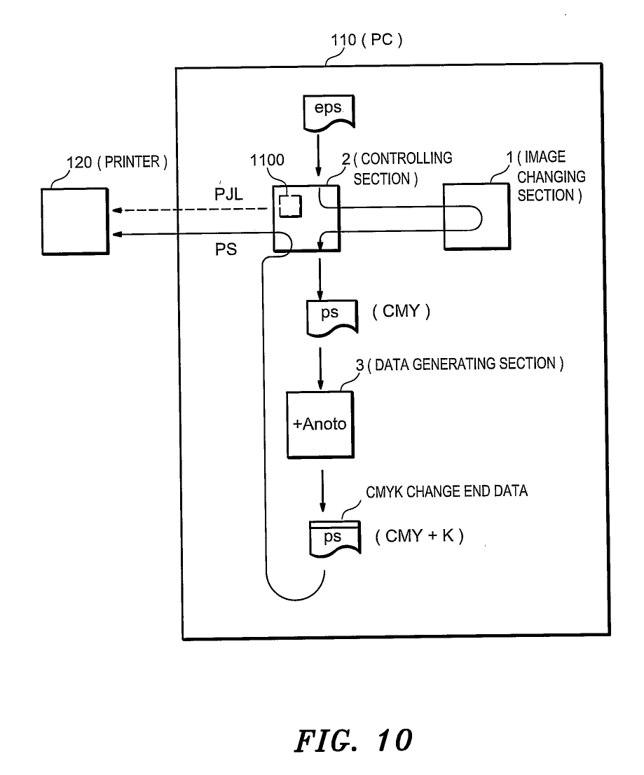

FIG. 9 is a block diagram showing a structure of an image forming system in embodiment 4 of the present invention; and FIG. 10 is a diagram showing flow of signal in an image forming system of embodiment 4 of the present invention.

As shown by FIG. 9, a PC 110 includes an image data storing section 1101, a standard RGB profile 1102, a coloring approximation use profile 1103, a standard RGB profile changing section 1104, a coloring approximation use profile changing section 1105, an Anoto pattern generating section 1106, and a print job generating section 1107. These components 1101˜1107 are the same as that in the embodiment 1. Moreover, the standard RGB profile 1102, the coloring approximation use profile 1103, the standard RGB profile changing section 1104 and the coloring approximation use profile changing section 1105 constitute an image changing section 1; and the Anoto pattern generating section 1106 and the print job generating section 1107 constitute a data generating section 3.

Further, a printer 120 includes an image data storing section 1201, a layer thickness controlling section 1202, and a print processing section 1203. These components 1201˜1203 are the same as that in the embodiment 1.

In the embodiment 4, when image data that has been changed to (C, M, Y, K (K=0)) values in the PC 110 is sent to the printer 120, a CMYK change end information is also sent to request the printer 120 not to perform a CMYK change process. The following is to explain operation of the embodiment 4 on the basis of the FIGS. 9 and 10.

### FIRST EXAMPLE

As shown by FIGS. 9 and 10, when sending the image data PS (CMY) composed of (C, M, Y, K (K=0)) values and changed by the coloring approximation use profile changing section 1105 to a data generating section 3, a controlling section 2 generates CMYK change end information 1108 and sends the CMYK change end information 1108 to the print job generating section 1107 of the data generating section 3.

The print job generating section 1107, after identified the CMYK change end information 1108, when generating a print job, appends the CMYK change end information 1108 as a head of print data and sends it to the printer 120 together with Anoto pattern data.

Then, the printer 120 identifies that the received image data has been changed by a CMYK change process, according to the CMYK change end information 1108. Continuously, in the printer 120, without performing a CMYK change process of image data, a compound image of image data and Anoto pattern data is printed on print medium by the print processing section 1203.

In the example, the CMYK change end information 1108 is appended as a head of the print data. However, it is possible to un-append a CMYK change information representing a request that the printer 120 needs to perform a CMYK change. In the case, the printer 120 identifies that the CMYK change information is not appended, then, does not perform a CMYK change process of image data.

### SECOND EXAMPLE

The second example has a structure different from the first example, as shown by broken line in FIGS. 9 and 10, a CMYK change off switch 1100 is provided in the controlling section 2 of the PC 110. Through an operation of user, a CMYK change off command (PJL) 1204 can be sent from the controlling section 2 to the printer 120.

In the case, the printer 120, when received the CMYK change off command (PJL) 1204, identifies that all image data to be received after now has been performed by a CMYK change process, then, in the printer 120, the CMYK change process of image data is not be performed.

According to the embodiment 4, when the printer 120 performs an Anoto print of the image data received from the PC 110 onto print medium, it is unnecessary to perform a complement change process and link profile change process that were performed in prior art. Therefore, it is possible to keep a high thruput when the printer 120 performs an Anoto print.

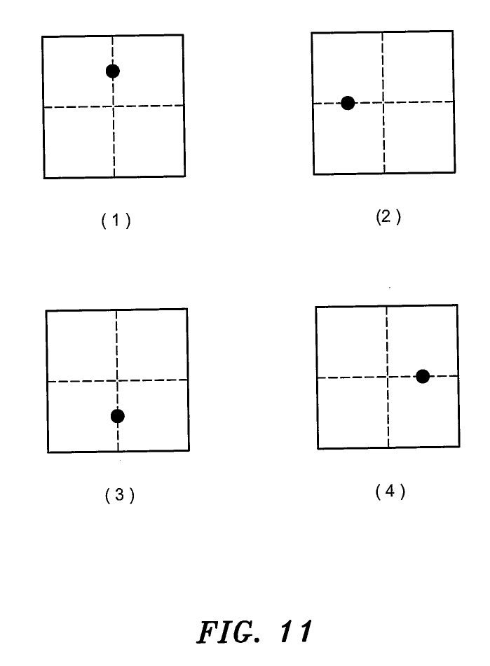

Next, it is to explain a formation of Anoto pattern in the Anoto pattern generating section 1106 on the basis of FIGS. 11˜14.

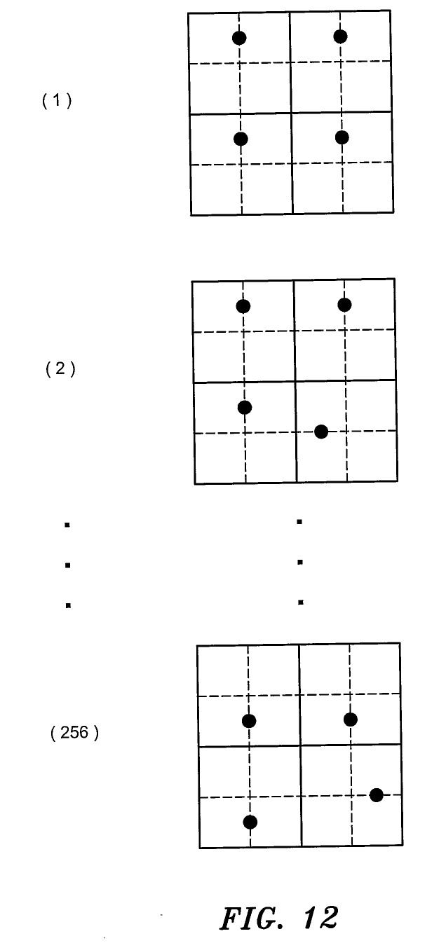

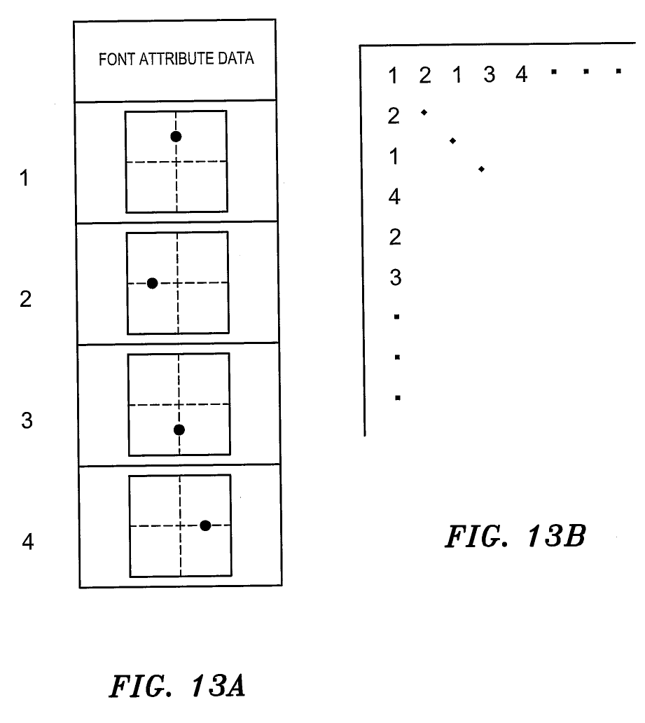

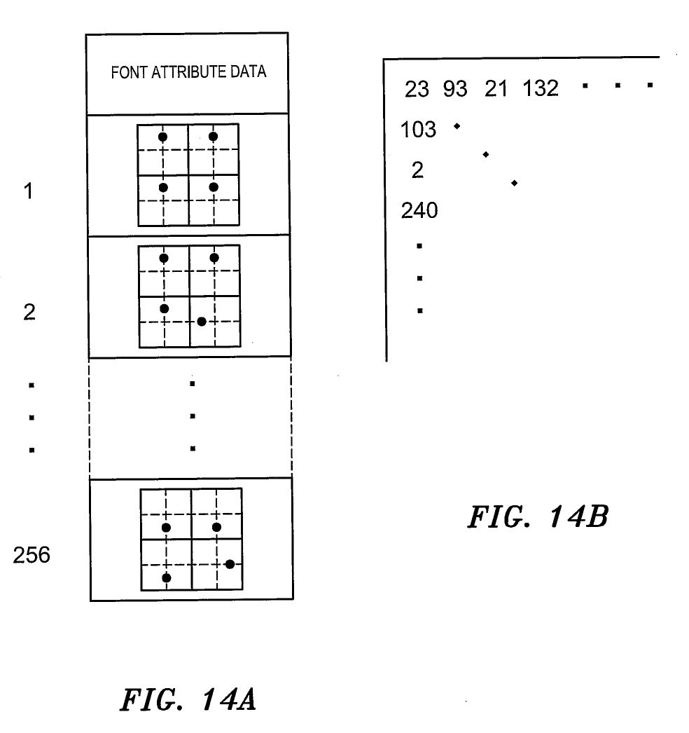

FIG. 11 is a diagrams showing basic Anoto dots; FIG. 12 is a diagram showing combinations of basic Anoto dots; FIG. 13A˜FIG. 13B are diagrams showing Anoto pattern according to basic Anoto dots; and FIG. 14A˜FIG. 14B are diagrams showing Anoto pattern according to combinations of basic Anoto dots.

Moreover, the Anoto pattern is slight dot pattern printed on paper corresponding to Anoto function, and is furnished in a predetermined interval with a grid shape. As stated above, through an Anoto pen to read each dot pattern, it is possible to detect the absolute position of the dot pattern on print medium.

As shown by FIG. 11, 4 basic Anoto dots are formed by respective dots. Each dot is located at a position that deviates slightly from a cross point of orthogonal imaginary grid lines along a longways direction or a widthways direction. The Anoto pattern generating section 1106 has font data that sets the 4 basic Anoto dots as character code data (first character code data), as shown by FIG. 11. The font data has, for example, about 1760 bytes.

When setting a default, as shown by FIG. 13B, through furnishing the 4 font data on paper (e.g. A4) according to a predetermined combination, a first Anoto pattern is generated. The character code data to represent the first Anoto pattern has, for example, about 694, 691 bytes. Moreover, as shown by FIG. 13B, the numerical characters on paper A4 correspond to the number (1˜4) of font attribute data in FIG. 13A. As Anoto pattern data, the font data and the character code data are sent to printer. That is, in a PS file to be sent to the printer, image data defined by CMY values and Anoto pattern data defined by K value are contained.

Further, as hown by FIG. 12, through optionally combining the 4 Anoto dots, respective character code data (second character code data) are formed as font data. The Anoto pattern generating section 1106 has the font data (e.g. about 2989 bytes). The total number of the font data obtained by combining the 4 basic Anoto dots is 256.

The Anoto pattern generating section 1106, as shown by FIG. 14B, generates a second Anoto pattern through furnishing the 256 font data on paper according to a predetermined combination. The character code data to represent the second Anoto pattern has, for example, 173, 63 bytes. Moreover, in the FIG. 14B, the numerical characters on paper correspond to the number (1˜256) of font attribute data in FIG. 14A.

In the embodiment, it is possible to select one of the first character code data and the second character code data so as to generate the Anoto pattern on print data.

Here, in the case to select the second character code data, though the font data to be sent increased by about 1200 bytes, the Anoto pattern data to be sent greatly decreased by about 520, 000 bytes. Therefore, through selecting the second character code data when generating Anoto pattern, it is possible to greatly reduce sending/receiving time of data, analysis time of data, and the like.

Moreover, in the embodiments described above, Anoto pattern data is designated by K value as background pattern data. Instead of the Anoto pattern data, other background pattern data can be used. In the case, color image data may be performed by CMYK change and the other background pattern data may be designated by one of CMYK values.

What is claimed is:

1. An image forming system, comprising:
a color image processing apparatus; and
a color image forming apparatus that is connected with the color image processing apparatus,
wherein the color image processing apparatus has:
a color changing section that uses one of CMYK values to designate background pattern data when performing a CMYK change with respect to color image data generated in the color image processing apparatus;
wherein the color image forming apparatus has:
an image forming section that receives the color image data that has been performed by the CMYK change and the background pattern data that has been designated by one of CMYK values from the color image processing apparatus, and compounds the both data to form an color image.

2. The image forming system according to claim 1,
wherein the background pattern data is Anoto pattern data;
the color image data is performed by a CMY change; and
the Anoto pattern data is designated by K value.

3. The image forming system according to claim 1, further comprising:
a coloring approximation use profile that makes a coloring of the color image printed on print medium be approximate to a coloring of an image displayed on displayer,
wherein the color changing section performs a CMYK change with respect to the color image data made in the color image processing apparatus on the basis of the coloring approximation use profile.

4. The image forming system according to claim 1,
wherein the color image processing apparatus further has:
a coloring approximation use profile storing section that at least stores the coloring approximation use profile corresponding to the color image forming apparatus which instructs a print; and
a profile selecting section that selects the coloring approximation use profile corresponding to the color image forming apparatus which instructs a print from coloring approximation use profiles stored in the coloring approximation use profile storing section when a print is instructed.

5. The image forming system according to claim 4,
wherein the color image processing apparatus further has:
a coloring approximation use profile obtaining section that obtains a coloring approximation use profile which will be stored in the coloring approximation use profile storing section from external apparatus except its own apparatus; and
a coloring approximation use profile writing section that writes the coloring approximation use profile obtained by the coloring approximation use profile obtaining section into the coloring approximation use profile storing section.

6. An image processing apparatus that is connected with a color image forming apparatus that compounds color image data with background pattern data, comprising:
a color changing section that uses one of CMYK values to designate background pattern data when performing a CMYK change with respect to color image data that is previously generated; and
a sending section that sends the color image data that has been performed by the CMYK change and the background pattern data that has been designated by one of CMYK values to the color image forming apparatus.

7. The image forming apparatus according to claim 6,
wherein the background pattern data is Anoto pattern data;
the color image data is performed by a CMY change; and
the Anoto pattern data is designated by K value.

8. The image processing apparatus according to claim 6, further comprising:
a coloring approximation use profile that makes a coloring of the color image printed on print medium be approximate to a coloring of an image displayed on displayer,
wherein the color changing section performs a CMYK change with respect to the color image data made in the color image processing apparatus on the basis of the coloring approximation use profile.

9. The image processing apparatus according to claim 6, further comprising:
a coloring approximation use profile storing section that at least stores the coloring approximation use profile corresponding to the color image forming apparatus which instructs a print; and
a profile selecting section that selects the coloring approximation use profile corresponding to the color image forming apparatus which instructs a print from coloring approximation use profiles stored in the coloring approximation use profile storing section when a print is instructed.

10. The image processing apparatus according to claim 9, further comprising:
a coloring approximation use profile obtaining section that obtains a coloring approximation use profile which will be stored in the coloring approximation use profile storing section from external apparatus except its own apparatus; and
a coloring approximation use profile writing section that writes the coloring approximation use profile obtained by the coloring approximation use profile obtaining section into the coloring approximation use profile storing section.

11. An image processing method that outputs a print instruction to a color image forming apparatus that compounds color image data with background pattern data, comprising steps of:
using one of CMYK values to designate background pattern data when performing a CMYK change with respect to color image data that is previously generated; and
sending the color image data that has been performed by the CMYK change and the background pattern data that has been designated by one of CMYK values to the color image forming apparatus.

12. The image forming method according to claim 11,
wherein the background pattern data is Anoto pattern data;
the color image data is performed by a CMY change; and
the Anoto pattern data is designated by K value.

13. The image processing method according to claim 11, further comprising step of:
using a coloring approximation use profile that makes a coloring of the color image printed on print medium be approximate to a coloring of an image displayed on displayer,
wherein a CMYK change is performed with respect to the color image data made in a color image processing apparatus on the basis of the coloring approximation use profile previously stored.

14. The image processing method according to claim 11, further comprising steps of:
using a coloring approximation use profile storing section to at least store the coloring approximation use profile corresponding to the color image forming apparatus which instructs a print; and
selecting the coloring approximation use profile corresponding to the color image forming apparatus which instructs a print from coloring approximation use profiles stored in the coloring approximation use profile storing section when a print is instructed.

15. The image processing method according to claim 14, further comprising steps of:
obtaining a coloring approximation use profile which will be stored in the coloring approximation use profile storing section from external apparatus except its own apparatus; and
writing the coloring approximation use profile obtained by the coloring approximation use profile obtaining section into the coloring approximation use profile storing section.

16. The image processing method according to claim 11, further comprising step of:
sending CMYK change end information to avoid a CMYK change process in the color image forming apparatus, when sending the color image data that has been performed by a CMYK change to the color image forming apparatus.

17. The image processing method according to claim 12, further comprising step of:
selecting one of first character code data that is obtained by 4 basic Anoto dots that are located at positions that deviate slightly from a cross point of orthogonal imaginary grid lines along respective different directions; and second character code data that is formed through optionally combining the 4 basic Anoto dots, to use the selected character code data as the Anoto pattern data.
